(19) United States
(12) Patent Application Publication
(10) Pub. No.: US 2004/0115983 A1
(43) Pub. Date: Jun. 17, 2004

(54) Electrical plug with reduced cross talk

(76) Inventor: Yu-Ho Liang, Chung Ho City (TW)

Correspondence Address: TROXELL LAW OFFICE PLLC, SUITE 1404, 5205 LEESBURG PIKE, FALLS CHURCH, VA, 22041, US

(21) Appl. No.: 10/408,313

(22) Filed: Apr. 8, 2003

(30) Foreign Application Priority Data
Dec. 11, 2002 (TW) 091220103

(51) Int. Cl. H01R 4/50; H01R 13/625

(52) U.S. Cl. 439/344

(57) ABSTRACT

An electrical plug includes an insulative body defining an open space and having a bottom face defining slots in communication with the open space. A number of conductors are arranged in a predetermined sequence inside the open space to form a conductor row. At least one of the conductors is removed from the row, which forms a vacancy in the row, and is relocated at an outer position with respect to the conductor row. Primary and secondary conductive pins are received in the slots and partially extend into the open space to physically engage the un-relocated and relocated conductors respectively. The secondary conductive pin includes an extension received in one of the slots that corresponds in position to the vacancy in the row of the conductors. The extension has a surface area smaller than that of the conductive pins. Interference caused by cross talk between adjacent pins or conductors is reduced by the relocation of the at least one relocated conductive pin with respect to the conductor row and the reduced surface area of the extension of the secondary conductive pin.

### FIELD OF THE INVENTION

The present invention generally relates to the field of electrical connection, such as a communication plug comprising a number of pins connected with separate wires, and in particular to an electrical plug having reduced cross talk among the wires.

### BACKGROUND OF THE INVENTION

A communication plug, such as a RJ45 plug, comprising a number pins respectively connected to separate wires, is mateable with a jack. FIG. 1 of the attached drawings shows a conventional plug comprising an insulative body 1 in which a number of conductors or wires 11 are secured. A number of slots (not labeled) are defined in the body 1 and extends vertically from a bottom face of the body 1 to a position adjacent to a top face of the body 1. Each slot receives and retains a conductive pin that is electrically connected to the respectively wire 11. The plug body 1 has a small size and compact arrangement of the conductive pins whereby electromagnetic interference, known as “cross talk”, may be caused between adjacent pins or wires. Noise is thus induced in the wires, which deteriorates quality of communication.

Thus, it is desired to have an electrical plug that reduces cross talk between adjacent terminals so as to overcome the problem encountered in the prior art.

### SUMMARY OF THE INVENTION

An object of the present invention is to provide an electrical plug comprising a number of sequentially arranged conductors of which at least one is removed from the original sequence and relocated at an outermost side position of the conductors, and a number of conductive pins arranged in accordance with the original sequence of the conductors and respectively connected thereto, at least one of the conductive pins having an extension to engage the outermost side relocated conductor whereby cross talk occurring between adjacent conductors or conductive pins is effectively reduced with a simply modified construction.

Another object of the present invention is to provide an electrical plug wherein the extension of the at least one conductive pin having a reduced surface area doe further reducing cross talk with adjacent conductive pins.

A further object of the present invention is to provide an electrical plug comprising an insulative body defining an open space into which an insert is received and retained, the insert defining grooves for accommodating and positioning the conductors therein to properly position the conductors and to facilitate electrical engagement between the conductive pins and the conductors, the number of the slots defined in the insert being at least one greater than the number of the conductors for accommodating the extension of the at least one relocated pin.

To achieve the above objects, in accordance with the present invention, there is provided electrical plug comprising an insulative body defining an open space and having a bottom face defining slots in communication with the open space. A number of conductors are arranged in a predetermined sequence inside the open space to form a conductor row. At least one of the conductors is removed from the row, which forms a vacancy in the row, and is relocated at an outer position with respect to the conductor row. Primary and secondary conductive pins are received in the slots and partially extend into the open space to physically engage the un-relocated and relocated conductors respectively. The secondary conductive pin comprises an extension received in one of the slots that corresponds in position to the vacancy in the row of the conductors. The extension has a surface area smaller than that of the conductive pins. Interference caused by cross talk between adjacent pins or conductors is reduced by the relocation of the at least one relocated conductive pin with respect to the conductor row and the reduced surface area of the extension of the secondary conductive pin.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of a conventional electrical plug;

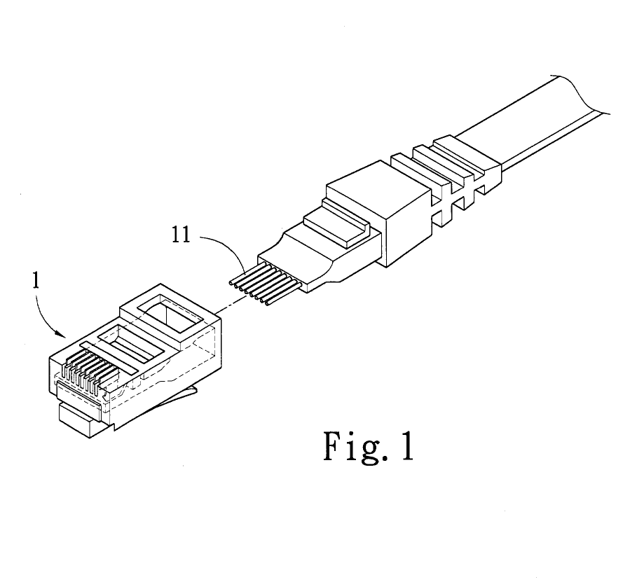

FIG. 2 is a perspective view of an electrical plug constructed in accordance with the present invention;

FIG. 3 is an exploded view of the electrical plug of the present invention;

FIG. 4 is a cross-sectional view of the electrical plug of the present invention;

FIG. 5 is another cross-sectional view of the electrical plug of the present invention; and

FIG. 6 is another perspective view of the electrical plug of the present invention.

### DETAILED DESCRIPTION OF THE PREFERRED EMBODIMENT

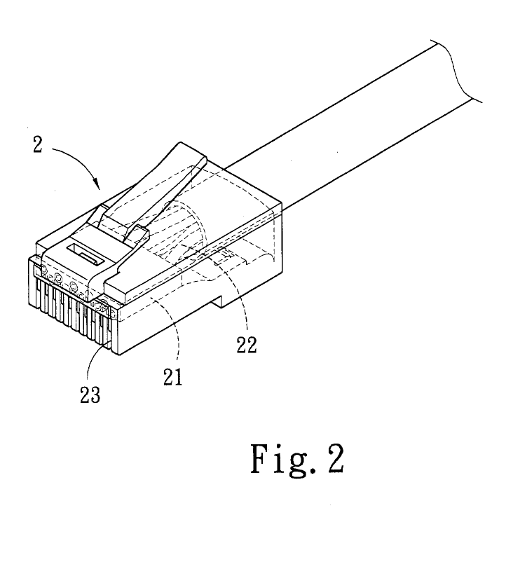

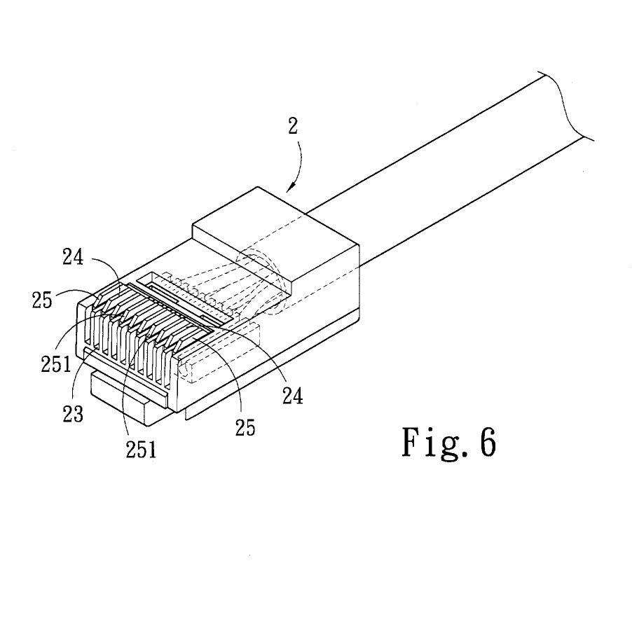

With reference to the drawings and in particular to FIGS. 2 and 6, an electrical plug constructed in accordance with the present invention comprises an insulative body 2 mounted to an end of a cable comprised of a number of conductors or wires 22. The conductors 22 extend into the insulative body 2 and are electrically connected to primary and secondary conductive pins 24, 25 received and retained in slots 23 defined in the insulative body 2.

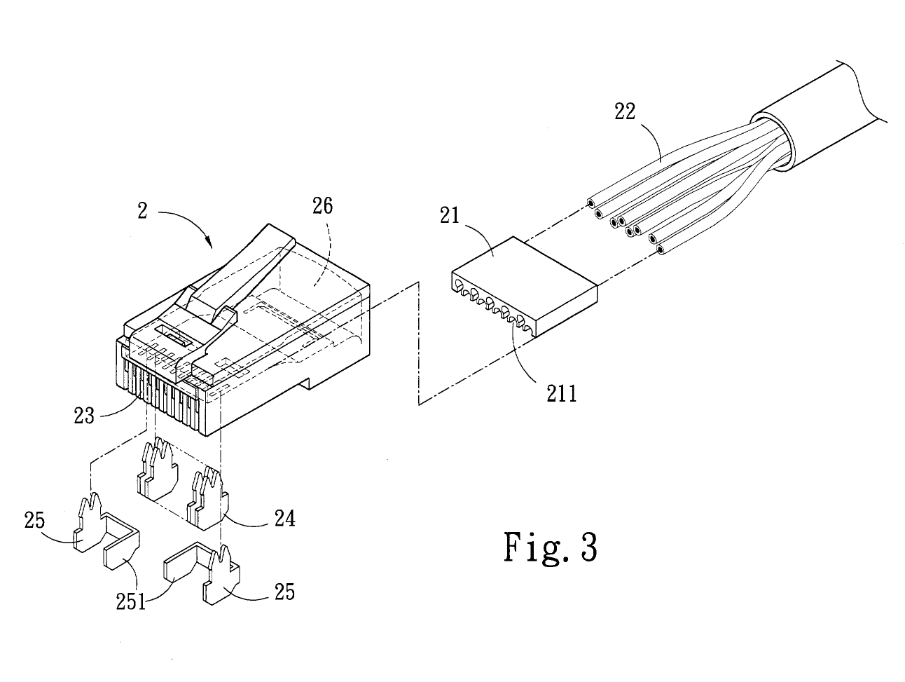

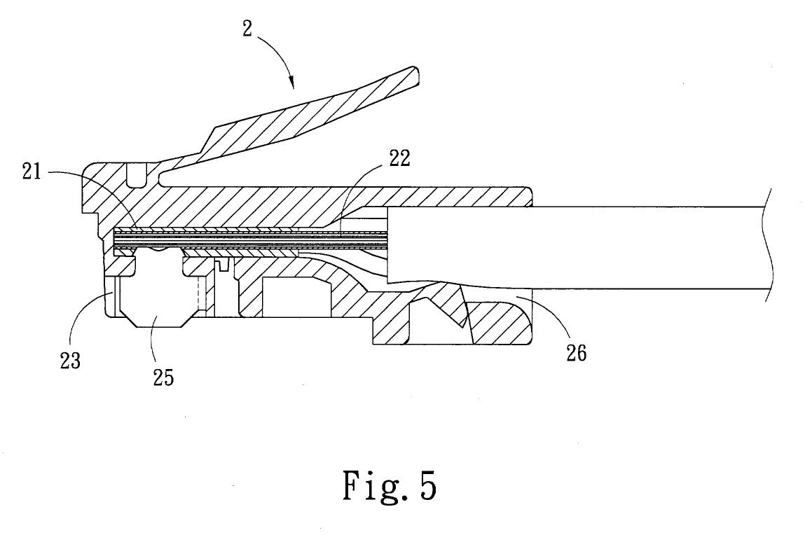

Also referring to FIGS. 3-5, the insulative body 2 has a rear end (not labeled) defining an open space 26 for receiving an end of the cable and an opposite front end configured to releasably mate a socket (not shown), such as a wall jack. The insulative body 2 also has opposite top and bottom faces (not labeled) connecting between the front and rear ends. The slots 23 are defined in the bottom face of the insulative body 2 and are in communication with the open space 26. The primary and secondary conductive pins 22 are received and retained in the slots 23 and partially extend into the open space 26. In the embodiment illustrated, there are six primary conductive pins 24 and two secondary conductive pins 25. The cable that extends into the plug body 2 comprises a number of conductors 22 respectively corresponding to the primary and secondary conductive pins 24, 25 and electrically connected thereto.

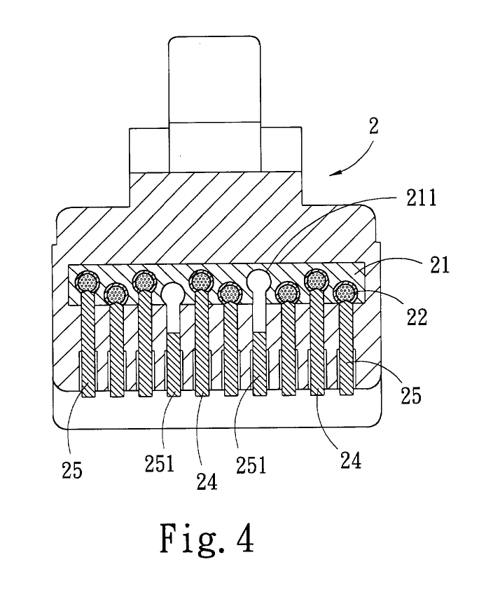

An insert 21, preferably made of insulation, is received in the open space 26 of the plug body 2. The insert 21 defines grooves 211 in which the conductors 22 are received and retained. The insert 21 is sized to tightly fit into the open space 26 with the conductors 22 whereby the conductors 22 are securely positioned inside the plug body 2 by the insert 21. The grooves 211 are arranged in an alternate manner whereby adjacent conductors 22 are offset from each other. This reduces the potential interference of cross talk caused by to high frequency electrical signals traveling through the conductors. The conductors 22 are arranged as a row in a predetermined sequence with the adjacent ones offset from each other. In accordance with the present invention, at least one of the conductors 22 is removed from the original sequence and relocated at an outermost side position with respect to the conductor row whereby the original location of the relocated conductor is vacant. To accommodate the vacancy of the relocated conductor 22, the total number of the grooves 211 of the insert 21 (as well as that of the slots 23 defined in the plug body 2 and exactly corresponding to the grooves 21) is increased by the number of the relocated conductor with respect to the number of the conductors 22. In the embodiment illustrated and as shown in FIG. 4, two conductors 22 are relocated to the outermost positions of the conductor row whereby the number of the grooves 211 of the insert 21 is two more than that of the conductors 22. The relocation of some of the conductors 22 helps reducing cross talk between adjacent conductors 22. It is noted that the number of the relocated conductors 22 corresponds to that of the secondary conductive pins 25 to which the relocated conductors 22 are electrically connected.

The primary conductive pins 24 are retained in the slots 23 and correspond in position to the conductors 22 of the original sequence, namely the un-relocated conductors 22, while the secondary conductive pins 25 are retained in the outermost ones of the slots 23 to be corresponding to the relocated conductors 22. Each primary conductive pin 24 has a top sharp portion (not labeled) extending into the groove 211 of the corresponding conductor 22 to physically engage the conductor 22. The secondary conductive pins 25 have a top sharp portion (not labeled) extending into the outermost groove 211 in which the relocated conductors 22 are retained for physically engaging the relocated conductors 22. Each secondary conductive pin 25 further comprises an extension 251 that is received and retained in the slots 23 that are corresponding to the original position of the relocated conductors 22, namely the vacancy of the row of the conductors, and electrically connected to the secondary conductive pin 25. In the embodiment illustrated, the secondary conductive pin 25 is integrally formed with the extension 251. However, it is apparent that the secondary conductive pin 25 and the extension 251 can be made separately and electrically connected together by an additional conductive member (not shown).

The extension 251 of the secondary conductive pin 25 has a surface area smaller than that of the primary and secondary conductive pins 24, 25 for further reducing the interference caused by cross talk.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An electrical plug comprising:
an insulative body defining an open space and having a bottom face defining a first number of slots in communication with the open space;
a second number of conductors arranged in a predetermined sequence inside the open space to form a row, the second number being greater than the first number, the conductors being grouped as un-relocated conductors and at least one relocated conductor that is removed from the predetermined sequence and relocated at an outer position with respect to the row, a vacancy being formed in the sequence corresponding to the removal of the relocated conductor;
a third number of primary conductive pins received in the slots and respectively corresponding to the un-relocated conductors, the primary conductive pins partially extending into the open space to physically engage the un-relocated conductors; and
a secondary conductive pin received in the slot corresponding to each relocated conductor and partially extending into the open space for physically engaging the relocated conductor, the second conductive pin comprising an extension received in one of the slots that corresponds in position to the vacancy in the row of the conductors.

2. The electrical plug as claimed in claim 1 further comprising an insert defining grooves for receiving and retaining the conductors, the insert being tightly received in the open space for securely positioning the conductors in the plug body.

3. The electrical plug as claimed in claim 1, wherein the second number is greater than the first number by at least one whereby the conductors comprise at least one relocated conductor arranged at the outer side of the row of the conductors.

4. The electrical plug as claimed in claim 1, wherein the extension of the secondary conductive pin has a surface area smaller than a surface area of an adjacent one of the conductive pins.

5. The electrical plug as claimed in claim 1, wherein the extension of the secondary conductive pin is separate from the secondary conductive pin and is electrically connected thereto by a conductive member.
